(19) United States
(12) Patent Application Publication
(10) Pub. No.: US 2013/0241464 A1
(43) Pub. Date: Sep. 19, 2013

(54) FUEL CELL HYBRID SYSTEM AND METHOD FOR CHARGING RECHARGEABLE BATTERY THEREOF

(71) Applicant: SAMSUNG SDI CO., LTD., Yongin-si (KR)

(72) Inventors: Dong-Rak KIM, Yongin-si (KR); In-Seob SONG, Yongin-si (KR); Jeong-Kurn PARK, Yongin-si (KR); Jong-Rock CHOI, Yongin-si (KR); Hye-Jung CHO, Yongin-city (KR)

(73) Assignee: SAMSUNG SDI CO., LTD., Yongin-si (KR)

(21) Appl. No.: 13/719,365

(22) Filed: Dec. 19, 2012

Related U.S. Application Data
(60) Provisional application No. 61/610,886, filed on Mar. 14, 2012.

(51) Int. Cl. H02J 7/00

(52) U.S. Cl. CPC H02J 7/00
USPC 320/101

(57) ABSTRACT

A fuel cell hybrid system extends a cycle-life of a rechargeable battery by charging the rechargeable battery with voltage lower than the maximum charging voltage of the rechargeable battery by a predetermined level.

### CLAIM OF PRIORITY

This application claims priority to and the benefit of Provisional Application No. 61/610,886, filed on 14 Mar. 2012, in The United States Patent and Trademark Office, the entire content of which is incorporated herein by reference.

### BACKGROUND OF THE INVENTION

1. Field of the Invention

Aspects of the present invention generally relate to a fuel cell hybrid system and a method for charging a rechargeable battery in the fuel cell hybrid system.

2. Description of the Related Art

Various rechargeable batteries such as a lead storage battery, an alkali storage battery, a lithium-ion battery, a nickel metal hydride battery, a nickel-cadmium battery, and the like, are being used. Among the various rechargeable batteries, the lithium-ion battery has excellent advantages compared to other rechargeable batteries and thus, is being widely used.

The above information disclosed in this Related Art section is only for enhancement of understanding of the background of the invention and therefore it may contain information that does not form the prior art that is already known in this country to a person of ordinary skill in the art.

### SUMMARY OF THE INVENTION

Aspects of the present invention provide for a fuel battery hybrid system that may extend the cycle-life of a lithium-ion battery, and a method for charging a rechargeable battery incorporate in a fuel cell hybrid system.

The fuel cell hybrid system may extend the cycle-life of the rechargeable battery by charging the rechargeable battery with a voltage level that is lower than the maximum charging voltage of the rechargeable battery by a predetermined level.

The fuel cell hybrid system may extend the cycle-life of the rechargeable battery by reducing the rate of loss of capacity of the rechargeable battery due to repeated charging and discharging of the battery.

To attain a reduction in the rate of loss of capacity by the rechargeable battery, it is possible to reduce the design capacity of the rechargeable battery. By employing the low-capacity rechargeable battery in the fuel cell hybrid system, it is also possible to reduce the production cost of a product.

As charging voltage of the rechargeable battery becomes lower, it is possible to improve the efficiency of a converter by reducing the boosting ratio of the converter.

An exemplary embodiment of the present invention generally relates to a fuel cell hybrid system. This fuel cell may include a fuel cell stack to generate an electrical current; a rechargeable battery; a direct current to direct current(dc/dc) converter electrically connected to the fuel cell stack and the rechargeable battery; and a control unit electrically connected to the dc/dc converter to control the charging of the rechargeable battery by causing the dc/dc converter to output the electrical current received from the fuel cell stack at a voltage level that is less than a maximum charging voltage of the rechargeable battery.

The dc/dc converter may further include a first distributed resistance electrically connected to the fuel cell stack and the rechargeable battery; and a second distributed resistance electrically connected to the first distributed resistance and the control unit.

The control unit may alter the voltage level to the rechargeable battery by altering a resistance level in at least one of either the first distributed resistance or the second distributed resistance.

The control unit may alter the voltage level to the rechargeable battery by altering the resistance level in both the first distributed resistance and the second distributed resistance.

The fuel cell hybrid system may further include a current measurement unit electrically connected to the fuel cell stack, the dc/dc converter and the control unit to measure the electrical voltage from the fuel cell stack and transmit a current amount signal to the control unit indicative of an amount electrical current being generated by the fuel cell stack.

The dc/dc converter may further include a power converter electrically connected between the fuel cell stack and the rechargeable battery; a first amplifier electrically connected between the control unit and the power converter; and a second amplifier electrically connected between the first amplifier and the power converter. A first end of the first distributed resistor is connected to a first node located between the power converter and the rechargeable battery. A second end of the first distributed resistor is connected to a second node located between an output of the first amplifier and an input of the second amplifier. A first end of the second distributed resistor is connected to the second node. A second end of the second distributed resistor is connected to the output of the first amplifier.

The dc/dc converter may include a power converter. The power converter, may further include: a first switch; a second switch; an inductor; and a capacitor. The first switch may include a gate connected to a switch controller included in the dc/dc controller, a first end of the first switch connected to the current measurement unit and a second end connected to a first end of the inductor. The second switch may include a gate connected to the switch controller, a first end connected to the second end of the first switch and a second end connected to a first terminal of the fuel cell stack. A second end of the inductor may be connected to a first end of the capacitor. A second end of the capacitor may be connected to a second terminal of the fuel cell stack.

The switch controller may vary an on-duty cycle of the first switch and the second switch on the basis of the current amount signal.

The control unit transfers an analog control signal based upon the performance of the fuel cell stack as indicated by the current amount signal to the dc/dc converter. Upon receipt of the analog control signal the power conversion efficiency of the dc/dc converter is altered.

The switch controller may vary the on-duty cycle of the first switch and the second switch on the basis of the analog control signal.

The control unit may change a voltage value of the analog control signal to set the charging voltage of the rechargeable battery.

At least one of the first distributed resistance and the second distributed resistance may be a variable resistance resistor.

Both the first distributed resistance and the second distributed resistance may be variable resistance resistors.

The rechargeable battery may be a lithium-ion rechargeable battery.

The charging voltage of the rechargeable battery may be in a range of equal to or less than 4.1 volts and equal to or greater than 4.0 volts.

The lithium-ion rechargeable battery may be charged and discharged in a high temperature environment.

The charging voltage of rechargeable battery may be in a range of equal to or less than 4.0 volts and equal to or greater than 3.8 volts.

The rechargeable battery may be utilized in a cellular phone.

The rechargeable battery may be utilized in a navigation system.

The rechargeable battery may be a lithium iron phosphate (LFP) rechargeable battery.

The charging voltage of rechargeable battery may be in a range of equal to or less than charging voltage 3.6 volts and equal to or greater than 3.4 volts.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a fuel cell hybrid system according to an exemplary embodiment of the present invention.

FIG. 2 is a graph to describe a general method for charging and discharging a rechargeable battery in a fuel cell hybrid system.

FIG. 3 is a graph to describe a method for charging and discharging a rechargeable battery in a fuel cell hybrid system according to an exemplary embodiment of the present invention.

FIG. 4 is a graph illustrating an example of comparative testing on a change in the available capacity of a rechargeable battery according to charging voltage.

FIG. 5 is a graph illustrating another example of comparative testing on a change in the available capacity of a rechargeable battery according to charging voltage.

FIG. 6 is a graph illustrating still another example of comparative testing on a change in the available capacity of a rechargeable battery according to charging voltage.

### DETAILED DESCRIPTION OF THE EMBODIMENTS

The present invention will be described more fully hereinafter with reference to the accompanying drawings, in which the exemplary embodiments of the invention are shown. As those skilled in the art would realize, the described embodiments may be modified in various different ways, all without departing from the spirit or scope of the present invention.

Further, in various exemplary embodiments, constituent elements having the same configuration will be described in the first exemplary embodiment representatively using the same reference numerals. In other exemplary embodiments, only a configuration different from the first exemplary embodiment will be described.

The drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising,” will be understood to imply the inclusion of stated elements but not the exclusion of any other elements.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A lithium-ion battery may be very light and has a high energy density of two folds of the nickel-cadmium battery and six folds of the lead storage battery. The lithium-ion battery has advantages in that an electromotive force is great, the lithium-ion battery is chargeable even in an incomplete discharge state and power loss occurring due to self-discharge is very small. However, in the case of the lithium-ion battery, when a charging period at the maximum voltage for charging increases, side reaction such as electrolyte solution decomposition, overcharge, lithium electrodeposition, and the like, is deepened whereby a cycle-life is deteriorated.

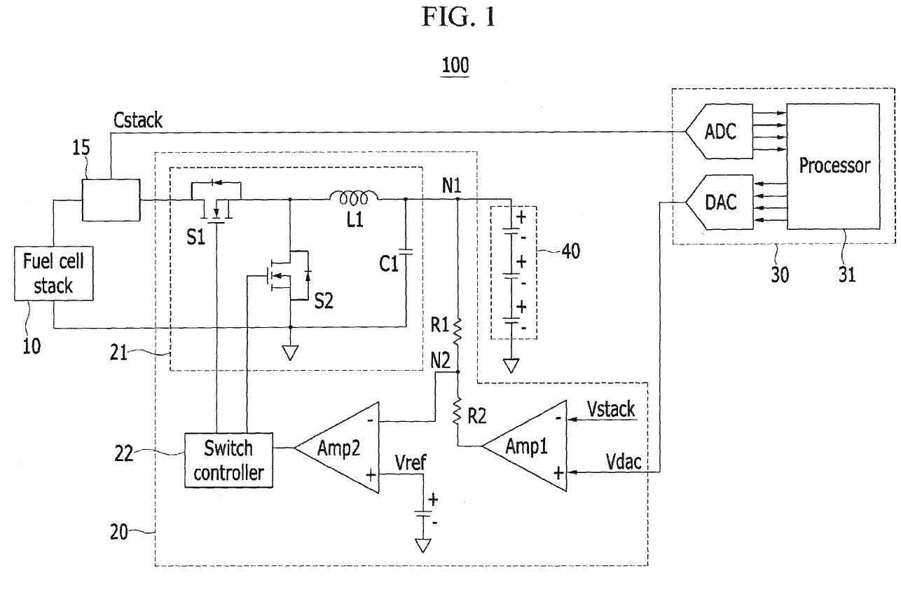

FIG. 1 illustrates a fuel cell hybrid system 100 according to an exemplary embodiment of the present invention.

Referring to FIG. 1, the fuel cell hybrid system 100 may include a fuel cell stack 10, a current measurement unit 15, a direct current to direct current (DC/DC) converter 20, a control unit 30, and a rechargeable battery 40.

The fuel cell stack 10 is supplied with fuel from a fuel storage unit (not shown) and is supplied with an oxidizing agent from an oxidizing agent supply unit (not shown) to produce electrical energy. Fuel used in the fuel cell hybrid system 100 commonly refers to carbon hydrogen based fuel in a liquid or gaseous state such as methanol, ethanol or natural gas, liquefied petroleum gas (LPG), and the like. As an oxidizing agent reacting to hydrogen, the fuel cell hybrid system 100 may use oxygen gas stored in a separate storage means or may use air.

The fuel cell stack 10 may produce electrical energy according to various schemes. For example, a polymer electrode membrane fuel cell (PEMFC) scheme or a direct oxidation fuel cell scheme may be employed. The PEMFC scheme is a scheme of generating hydrogen by reforming fuel and generating electrical energy by electrochemically reacting hydrogen and oxygen. The direct oxidation fuel cell is a scheme of generating electrical energy through direct reaction between liquid or gas fuel and oxygen in a unit cell.

The current measurement unit 15 is connected to a first terminal of the fuel cell stack 10. The current measurement unit 15 produces a current amount signal (Cstack) by measuring current flowing from the fuel cell stack 10. The current measurement unit 15 transfers the current amount signal (Cstack) to the control unit 30.

The control unit 30 may include an analog-to-digital converter (ADC), a processor 31, and a digital-to-analog converter (DAC).

The ADC converts, to a digital signal, the current amount signal (Cstack) of the fuel cell stack 10 that is an analog signal, and transfers the converted digital signal to the processor 31. The current amount signal (Cstack) indicates a current amount flowing from the fuel cell stack 10. The ADC may generate a digital current amount signal corresponding to a current amount indicated by the current amount signal (Cstack).

The processor 31 responds to the reception of the digital current amount signal to generate a digital control signal for adjusting the power conversion efficiency of the DC/DC converter 20. The processor 31 may evaluate performance of the fuel cell stack 10 based on the digital current amount signal. When the digital current amount signal value is greater than a predetermined threshold value, the processor 31 may determine that the performance of the fuel cell stack 10 is in a normal state. When the digital current amount signal value is less than the predetermined threshold value, the processor 31 may determine that the performance of the fuel cell stack 10 has deteriorated.

The DAC converts the digital control signal to an analog control signal (Vdac). Thereafter, the analog control signal (Vdac) is transferred to the DC/DC converter 20.

The DC/DC converter 20 may adjust the power conversion efficiency of output power of the fuel cell stack 10 based on the analog control signal (Vdac). The DC/DC converter 20 transfers the output power of the fuel cell stack 10 to the rechargeable battery 40.

The DC/DC converter 20 may include a power converter 21, a first amplifier Amp1, a second amplifier Amp2, a first distributed resistance R1, a second distributed resistance R2, and a switch controller 22.

The power converter 21 may include a first switch S1, a second switch S2, an inductor L1, and a capacitor C1.

The first switch S1 may include a gate connected to the switch controller 22 with one end connected to the current measurement unit 15, and another end connected to one end of the inductor L1.

The second switch S2 may include a gate connected to the switch controller 22, one end connected to another end of the first switch S1, and another end connected to a second terminal of the fuel cell stack 10.

The inductor L1 may include one end connected to another end of the first switch S1 and another end connected to one end of the capacitor C1.

The capacitor C1 may include one end connected to another end of the inductor L1 and another end connected to the second terminal of the fuel cell stack 10.

The power converter 21 may convert output power of the fuel cell stack 10 according to a switching operation between the first switch S1 and the second switch S2 and transfers the converted output power to a first node N1. When the first switch S1 is turned on, a current amount transferred to the first node N1 via the inductor L1 increases and voltage of the first node N1 becomes high. In this instance, energy is stored in the inductor L1 and the second switch S2 is in an off-state.

When the first switch S1 is turned off and the second switch S2 is turned on, current generated by the energy stored in the inductor L1 is transferred to the first node N1. During the above period, a current amount transferred from the inductor L1 to the first node N1 decreases and voltage of the first node N1 becomes low.

As described above, by alternately turning on the first switch S1 and the second switch S2, it is possible to adjust a current amount transferred to the first node N1 and voltage. A current amount transferred to the first node N1 and voltage are determined based on the duty cycles of the first switch S1 and the second switch S2.

The first amplifier Amp1 may include a first input end (−) in which stack voltage (Vstack) of the fuel cell stack 10 is input, a second input end (+) in which the analog control signal (Vdac) is input, and an output end from which a difference between the stack voltage (Vstack) and the analog control signal (Vdac) is amplified to predetermined gain and thereby output. The stack voltage (Vstack) may be measurement voltage or predetermined voltage of the fuel cell stack 10.

The first distributed resistance R1 may have one end connected to the first node N1 and another end connected to a second node N2.

The second distributed resistance R2 may have one end connected to the second node N2 and another end connected to an output end of the first amplifier Amp1.

At least one of the first distributed resistance R1 and the second distributed resistance R2 may be a variable resistance resistor. In this instance, the control unit 30 may adjust output voltage of the fuel cell stack 10 through the DC/DC converter 20 by changing the resistance of at least one of the first distributed resistance R1 and the second distributed resistance R2.

Voltage corresponding to a voltage difference between voltage of the first node N1 and output voltage of the first amplifier Amp1 is distributed to the first distributed resistance R1 and the second distributed resistance R2. Voltage of the second node N2 is transferred to a first input end (−) of the second amplifier Amp2.

The second amplifier Amp2 may include the first input end (−) in which the voltage of the second node N2 is input, a second input end (+) in which reference voltage (Vref) is input, and an output end from which a difference between two input signals is amplified and thereby output. The second amplifier Amp2 amplifies the difference between the reference voltage (Vref) and the voltage of the second node N2 to a predetermined gain and transfers the amplified voltage difference to the switch controller 22.

The switch controller 22 may be connected to the output end of the second amplifier Amp2 to control the duty cycles of the first switch S1 and the second switch S2 based on an output signal of the second amplifier Amp2.

The rechargeable battery 40 may be connected to the first node N1 and is charged with a current amount transferred to the first node N1 and voltage. Here, the rechargeable battery 40 may be a lithium-ion battery.

However, in addition to the lithium-ion battery, various types of rechargeable batteries such as a lithium polymer battery, a nickel-cadmium battery, a nickel metal hydride battery, a lead storage battery, an alkali storage battery, and the like may be employed for the rechargeable battery 40.

To secure the maximum capacity, the lithium-ion battery is charged according to a constant current charging scheme and a constant voltage charging scheme. The constant current charging scheme is a scheme of charging a battery with a constant current amount. The constant voltage charging scheme is a scheme of charging a battery with constant voltage.

According to the constant current charging scheme, the lithium-ion battery is charged until a state of charge (SOC) becomes 80% of maximum capacity. Since the lithium-ion battery is charged according to the constant current charging scheme, voltage of the lithium-ion battery gradually increases. While the voltage of the lithium-ion battery is gradually increasing, voltage of the lithium-ion battery reaches the maximum charging voltage when the SOC becomes 80% of maximum capacity. The maximum charging voltage indicates rated voltage for charging the lithium-ion battery with SOC at 100%.

When voltage of the lithium-ion battery reaches the maximum charging voltage, the lithium-ion battery is charged according to the constant voltage charging scheme until the SOC becomes 100%. In the constant voltage charging scheme, the SOC of the lithium-ion battery is fitted to 100% by gradually reducing a current amount while maintaining the maximum charging voltage.

In a section where the lithium-ion battery is charged according to the constant voltage charging scheme, voltage of the lithium-ion battery is maintained at the maximum charging voltage. According to an increase in the section where the lithium-ion battery is charged with the maximum charging voltage according to the constant voltage charging scheme, side reactions, such as an electrolyte solution decomposition, overcharge, lithium electrodeposition, and the like, is deepened whereby a cycle-life of the lithium-ion battery deteriorates.

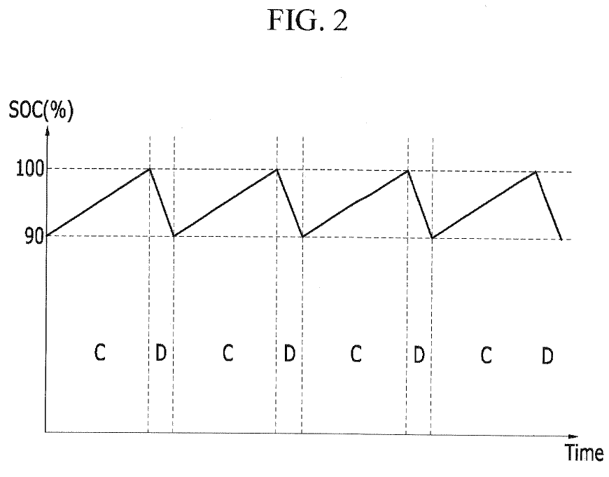

FIG. 2 is a graph to describe a general method for charging and discharging a rechargeable battery in a fuel cell hybrid system.

Referring to FIGS. 1 and 2, the fuel cell hybrid system 100 supplies power produced in the fuel cell stack 10 to a load and a balance of plant (BOP). While supplying the power to the load and the BOP, the fuel cell hybrid system 100 does not produce power in an air depletion section (D) to improve performance of the fuel cell stack 10. The air depletion section (D) is maintained for about 20 seconds for approximately every ten minutes. In the air depletion section (D), the rechargeable battery 40 is discharged in correspondence to the load and the BOP.

In a remaining section, excluding the air depletion section n(D), that is, a charging section (C) of about ten minutes, the rechargeable battery 40 is charged with the power produced in the fuel cell stack 10.

Due to discharge in the air depletion section (D), an SOC of the rechargeable battery 40 is assumed to decrease to be about 90% of maximum capacity. Also, a discharge amount of the rechargeable battery 40 in the air depletion section (D) is determined based on a power amount supplied to the load and the BOP.

The rechargeable battery 40 may be charged with the maximum charging voltage according to the constant voltage charging scheme in the charging section C, and the SOC of the rechargeable battery 40 reaches 100%. The charging section (C) of the rechargeable battery 40 is relatively long compared to the air depletion section (D).

As described above, in the fuel cell hybrid system 100, a process of charging the rechargeable battery 40 with the maximum charging voltage for a long period of time is repeated. In the case where the rechargeable battery 40 lithium-ion battery is charged with the maximum charging voltage for a long period of time, side reactions such as electrolyte solution decomposition, overcharge, lithium electrodeposition, and the like may be worsen. Accordingly, a cycle-life of the rechargeable battery 40 may deteriorate.

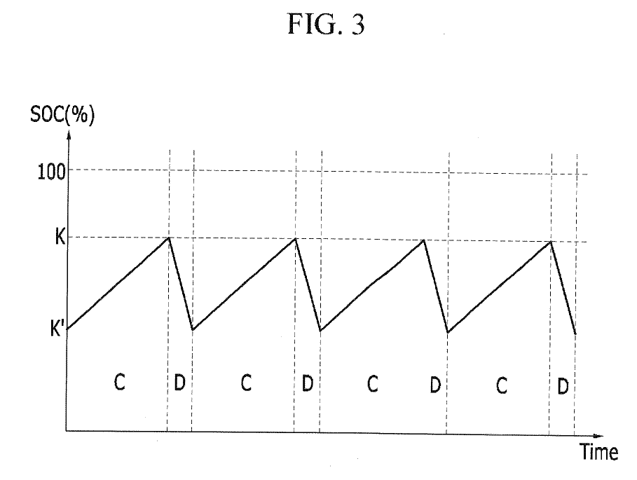

FIG. 3 is a graph describing a method for charging and discharging a rechargeable battery in a fuel cell hybrid system according to an exemplary embodiment of the present invention.

Referring to FIGS. 1 and 3, in the fuel cell hybrid system 100, the rechargeable battery 40 is charged with power produced in the fuel cell stack 10 in the charging section (C), and is discharged in correspondence to the load and the BOP in the air depletion section (D).

The DC/DC converter 20 of the fuel cell hybrid system 100 may convert output power of the fuel cell stack 10 to voltage lower than the maximum charging voltage of the rechargeable battery 40 by a predetermined level. The maximum charging voltage indicates rated voltage for charging the rechargeable battery with SOC 100% capacity.

Accordingly, the rechargeable battery 40 is charged with voltage lower than the maximum charging voltage in the charging section (C).

When the fuel cell hybrid system 100 charges the rechargeable battery 40 with charging voltage lower than the maximum charging voltage by a predetermined level, the rechargeable battery 40 is charged with SOC k % lower than SOC 100% in the charging section (C). That is, even though the rechargeable battery 40 is charged according to the constant voltage charging scheme, the rechargeable battery 40 is charged with charging voltage lower than the maximum charging voltage. Therefore, the SOC of the rechargeable battery 40 does not reach 100% of capacity.

For example, when the maximum charging voltage of the rechargeable battery 40 is 4.2V, the DC/DC converter 20 may convert the output power of the fuel cell stack 10 to a voltage of 4.1V and thereby charge the rechargeable battery 40. When the rechargeable battery 40 having the maximum charging voltage of 4.2V is charged with voltage of 4.1V, the rechargeable battery 40 is charged at about SOC 90%.

As described above, the fuel cell hybrid system 100 charges the rechargeable battery 40 with the first SOC K % by charging the rechargeable battery 40 with charging voltage lower than the maximum charging voltage by a predetermined level in the charging section (C). The fuel cell hybrid system 100 discharges the rechargeable battery 40 with second SOC K′% in the air depletion section (D).

The first SOC is determined based on a voltage value of charging voltage of the rechargeable battery 40, that is, a charging voltage lower than the maximum charging voltage by a predetermined level. The second SOC is determined based on a power amount supplied to the load and the BOP in the air depletion section (D).

The available capacity of the rechargeable battery 40 gradually decreases as charging and discharging are repeated. When the rechargeable battery 40 is charged and discharged with the maximum charging voltage up to a reference cycle, the available capacity of the rechargeable battery 40 quickly decreases. On the other hand, when the rechargeable battery 40 is charged and discharged with the charging voltage lower than the maximum charging voltage up to the reference cycle, the available capacity of the rechargeable battery 40 slowly decreases as opposed to the case where more rapid deterioration is seen with maximum charging voltage.

When the rechargeable battery 40 is charged and discharged with the charging voltage lower than the maximum charging voltage by a predetermined level up to the reference cycle, the available capacity of the rechargeable battery 40 in the reference cycle varies based on a voltage value of the charging voltage. The reference cycle indicates the minimum number of cycles enabling charge and discharge of the rechargeable battery 40 capable of satisfying the performance of the fuel cell hybrid system 100.

For example, in the fuel cell hybrid system 100, the rechargeable battery 40 needs to be chargeable and dischargeable at least 1000 times. In this case, the reference cycle of the rechargeable battery 40 may be determined as 1000 cycles.

In the fuel cell hybrid system 100, it is desirable that the available capacity of the rechargeable battery 40 is at least 50% of the initial design capacity of the rechargeable battery 40. Accordingly, even when the rechargeable battery 40 is charged and discharged up to the reference cycle as well as to the initial zero-th cycle, the available capacity of the rechargeable battery 40 needs to be at least 50% of the design capacity.

Accordingly, the charging voltage of the rechargeable battery 40 may be determined as charging voltage corresponding to a case where the available capacity of the rechargeable battery 40 is at least 50% of the design capacity when the rechargeable battery 40 is charged and discharged up to the reference cycle, among charging voltage lower than the maximum charging voltage by a predetermined level.

The charging voltage that satisfies the available capacity of the rechargeable battery 40 to be at least 50% of the design capacity in the reference cycle and that is lower than the maximum charging voltage is voltage within the range of about 92% to 98% of the maximum charging voltage. That is, the charging voltage is voltage lower than the maximum charging voltage by about 2% to 8%.

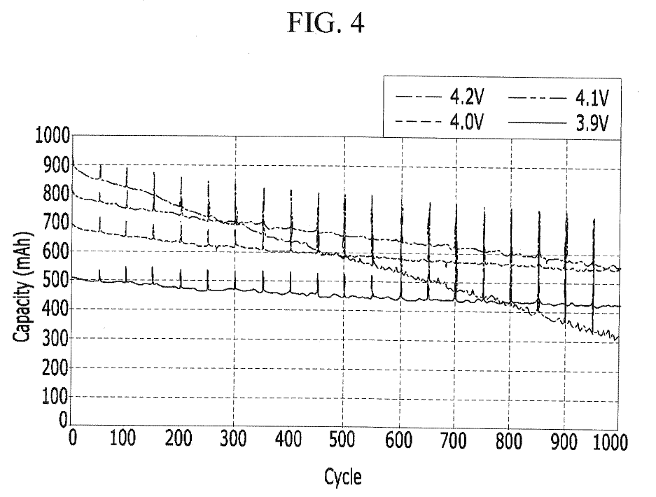

Alternatively, the charging voltage of the rechargeable battery 40 may be determined as voltage that maximizes the available capacity of the rechargeable battery 40 when the rechargeable battery 40 is charged and discharged up to the reference cycle in the charging voltage lower than the maximum charging voltage by a predetermined level. The charging voltage of the rechargeable battery 40 may be best illustrated through comparative test results. A comparative test example of determining the charging voltage of the rechargeable battery 40 will be described with reference to FIGS. 4 to 6.

As described above, by charging the rechargeable battery 40 with charging voltage lower than the maximum charging voltage by a predetermined level, it is possible to prevent a cycle-life of the rechargeable battery 40 from being deteriorated due to side reaction occurring when the rechargeable battery 40 is charged with the maximum charging voltage for a long period of time.

In the fuel cell hybrid system 100, to charge the rechargeable battery 40 with voltage lower than the maximum charging voltage in the charging section (C), output voltage of the DC/DC converter 20 needs to be outputted at voltage lower than the maximum charging voltage of the rechargeable battery 40.

A method of outputting the output voltage of the DC/DC converter 20 at the voltage lower than the maximum charging voltage of the rechargeable battery 40 includes a first method of changing resistance of the first distributed resistance R1 and the second distributed resistance R2, and a second method of changing a voltage value of the analog control signal (Vdac) in the control unit 30.

Initially, the first method of changing resistance of the first distributed resistance R1 and the second distributed resistance R2 will be described.

For example, assuming that when the first distributed resistance R1 and the second distributed resistance R2 have the same resistance, the DC/DC converter 20 changes the output power of the fuel cell stack 10 to the maximum charging voltage of the rechargeable battery 40.

Here, by changing the resistance of the first distributed resistance R1 and the second distributed resistance R2, it is possible to control the charging voltage of the rechargeable battery 40 to be lower than the maximum charging voltage. When the resistance of the first distributed resistance R1 is adjusted to be less than the resistance of the second distributed resistance R2, a voltage value of the second node N2 increases compared to a case where the first distributed resistance R1 and the second distributed resistance R2 have the same resistance. When the voltage value of the second node N2 increases, a difference between the voltage of the second node N2 and the reference voltage (Vref) increases. Therefore, an output value of the second amplifier Amp2 increases. The switch controller 22 adjusts the off-duty state of the first switch S1 and the second switch S2 to lower voltage output to the first node N1. When the voltage of the first node N1 becomes low, the difference between the voltage of the second node N2 and the reference voltage (Vref) decreases.

The switch controller 22 adjusts the off-duty state of the first switch S1 and the second switch S2 to lower voltage of the first node N1 so that the difference between the voltage of the second node N2 and the reference voltage (Vref) may become zero. Until the difference between the voltage of the second node N2 and the reference voltage (Vref) becomes zero, the voltage output to the first node N1 is lowered.

As described above, by changing the resistance of the first distributed resistance R1 and the second distributed resistance R2 of the DC/DC converter 20, it is possible to convert the output power of the fuel cell stack 10 to a voltage lower than the maximum charging voltage of the rechargeable battery 40.

Next, a second method of changing a voltage value of the analog control signal (Vdac) will be described. This second method utilizes the control unit 30.

The control unit 30 evaluates the performance (e.g., deterioration) of the fuel cell stack 10 based on the current amount signal (Cstack) indicating a current amount flowing from the fuel cell stack 10. The control unit 30 transfers, to the DC/DC converter 20, the analog control signal (Vdac) for adjusting the power conversion efficiency of the DC/DC converter 20 based on the performance of the fuel cell stack 10.

The DC/DC converter 20 converts power of the fuel cell stack 10 based on the analog control signal (Vdac) and transfers the converted power to the rechargeable battery 40. Specifically, the on-duty state of the first switch S1 and the second switch S2 varies based on the analog control signal (Vdac). Accordingly, regardless of deterioration of the fuel cell stack 10, the power transferred to the rechargeable battery 40 is controlled to be constant. In this instance, the control unit 30 according to an exemplary embodiment of the present invention may change a voltage value of the analog control signal (Vdac) to charge the rechargeable battery 40 with charging voltage lower than the maximum charging voltage.

For example, when the performance of the fuel cell stack 10 is in a normal state, the control unit 30 outputs the voltage value of the analog control signal (Vdac) at low voltage with a predetermined level.

When the voltage value of the analog control signal (Vdac) is output at the low voltage at a predetermined level, voltage output from the first amplifier Amp1 becomes low and a voltage value of the second node N2 decreases. When the voltage value of the second node N2 decreases, a difference between the voltage of the second node N2 and the reference voltage (Vref) increases. Accordingly, an output value of the second amplifier Amp2 increases.

The switch controller 22 decreases on-duty state of the first switch S1 to lower voltage output to the first node N1.

As described above, since the control unit 30 changes the voltage value of the analog control signal (Vdac), the rechargeable battery 40 is charged with voltage lower than the maximum charging voltage of the rechargeable battery 40.

Hereinafter, a comparative test result of measuring a capacity decrease rate of a rechargeable battery by charging the rechargeable battery with the maximum charging voltage and voltage lower than the maximum charging voltage will be described.

FIG. 4 is a graph illustrating an example of comparative testing on a change in the available capacity of a rechargeable battery according to charging voltage. In the graph, a horizontal axis indicates the number of charge and discharge cycles and a vertical axis indicates the capacity (mAh) of the rechargeable battery.

Referring to FIG. 4, the graph shows results of performing charging and discharging using charging voltage 4.2V, 4.1V, 4.0V, and 3.9V with respect to a lithium-ion rechargeable battery which is used for a mobile phone and of which maximum charging voltage is 4.2V.

Table 1 is the example of comparative testing on a change in the available capacity of the lithium-ion rechargeable battery using charging voltage 4.2V, 4.1V, 4.0V, and 3.9V.

TABLE 1

Capacity (mAh)

| Cycle | 4.2 V | 4.1 V | 4.0 V | 3.9 V |
|---|---|---|---|---|
| 0 | 920 | 825 | 695 | 510 |
| 100 | 820 | 755 | 650 | 490 |
| 200 | 750 | 720 | 640 | 480 |
| 300 | 706 | 695 | 620 | 475 |
| 400 | 630 | 688 | 600 | 470 |
| 500 | 590 | 655 | 590 | 450 |
| 600 | 540 | 645 | 585 | 450 |
| 700 | 475 | 620 | 580 | 450 |
| 800 | 420 | 600 | 580 | 430 |
| 900 | 375 | 590 | 550 | 420 |
| 1000 | 320 | 555 | 555 | 420 |

When charging and discharging is performed with the maximum charging voltage of 4.2V, the available capacity of the rechargeable battery quickly decreases with the increase in the number of cycles. On the other hand, when charging and discharging is performed with voltage lower than the maximum charging voltage, the available capacity of the rechargeable battery slowly decreases with the increase in the number of cycles.

The initial available capacity of the rechargeable battery in a case where charging and discharging is performed with charging voltage of 4.1V is small about 10% compared to a case where charging and discharging is performed with the maximum charging voltage of 4.2V. However, after the 400-th cycle, it can be seen that the available capacity of the rechargeable battery in the case where charging and discharging is performed with charging voltage of 4.1V is great compared to a case where charging and discharging is performed with the maximum charging voltage of 4.2V. The initial available capacity of the rechargeable battery in a case where charging and discharging is performed with charging voltage of 4.0V is small about 25% compared to a case where charging and discharging is performed with the maximum charging voltage of 4.2V. However, after the 500-th cycle, it can be seen that the available capacity of the rechargeable battery in a case where charging and discharging is performed with charging voltage of 4.0V is great compared to a case where charging and discharging is performed with the maximum charging voltage of 4.2V.

The reference cycle of the rechargeable battery 40 capable of satisfying the performance of the fuel cell hybrid system 100 is assumed as being 1000 cycles.

When comparing the available capacity of the rechargeable battery in a case where the rechargeable battery is charged and discharged with each of charging voltage 4.1V, 4.0V, and 3.9V up to the reference cycle, it can be seen that the available capacity of the rechargeable battery in two cases where charging and discharging is performed with the charging voltage of 4.1V and 4.0V is highest in the 1000-th cycle. When charging and discharging is performed with the charging voltage of 3.9V, it can be seen that the available capacity is about 45% of the design capacity in the 1000-th cycle.

Accordingly, when applying the rechargeable battery used for the comparative test to the fuel cell hybrid system 100, the charging voltage of the rechargeable battery to determine the first SOC may be determined as 4.1V to 3.9V. The charging voltage 4.1V, 4.0V, and 3.9V is charging voltage within the range of 92% to 98% of the maximum charging voltage.

Meanwhile, when 3.9V is used as the charging voltage of the rechargeable battery, loss of the available capacity of the rechargeable battery is substantial compared to a case where 4.1V or 4.0V is used as the charging voltage of the rechargeable battery. Therefore, it is preferred to use 4.1V or 4.0V as the charging voltage range.

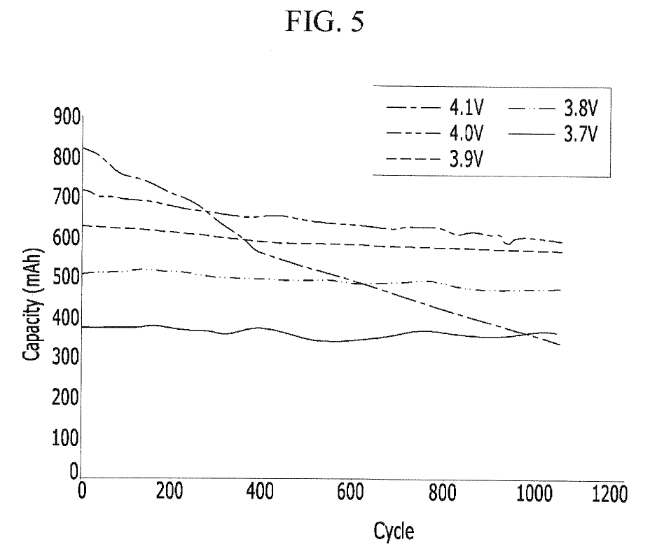

FIG. 5 is a graph illustrating another example of comparative testing on a change in the available capacity of a rechargeable battery according to charging voltage. In the graph, a horizontal axis indicates the number of charge and discharge cycles and a vertical axis indicates the capacity (mAh) of the rechargeable battery.

Referring to FIG. 5, the graph shows results of performing charging and discharging using charging voltage 4.1V, 4.0V, 3.9V, 3.8V, and 3.7V with respect to a rechargeable battery for a navigation system which is easily exposed in a high temperature environment. The rechargeable battery for navigation is designed to have an excellent internal material for a high temperature characteristic and the maximum charging voltage of 4.1V.

Table 2 is the example of comparative testing on a change in the available capacity of the rechargeable battery for a navigation device using charging voltage 4.1V, 4.0V, 3.9V, 3.8V and 3.7V.

TABLE 2

| | Capacity (mAh) | | | | |
|---|---|---|---|---|---|
| Cycle | 4.1 V | 4.0 V | 3.9 V | 3.8 V | 3.7 V |
| 0 | 820 | 710 | 620 | 500 | 380 |
| 100 | 755 | 690 | 615 | 510 | 380 |
| 200 | 720 | 680 | 610 | 520 | 380 |
| 300 | 650 | 670 | 605 | 500 | 375 |
| 400 | 550 | 660 | 600 | 500 | 397 |
| 500 | 525 | 650 | 600 | 500 | 370 |
| 600 | 500 | 640 | 600 | 500 | 370 |
| 700 | 475 | 630 | 600 | 510 | 390 |
| 800 | 450 | 630 | 600 | 510 | 395 |
| 900 | 425 | 625 | 600 | 490 | 385 |
| 1000 | 400 | 615 | 600 | 490 | 395 |

The initial available capacity of the rechargeable battery in a case where charging and discharging is performed with charging voltage of 4.0V is relatively small at about 13% compared to a case where charging and discharging is performed with the maximum charging voltage of 4.1V. However, after the 300-th cycle, it can be seen that the available capacity of the rechargeable battery in a case where charging and discharging is performed with charging voltage of 4.0V is great compared to a case where charging and discharging is performed with the maximum charging voltage of 4.1V.

The initial available capacity of the rechargeable battery in a case where charging and discharging is performed with charging voltage of 3.9V is also relatively small at about 25% compared to a case where charging and discharging is performed with the maximum charging voltage of 4.1V. However, after the 400-th cycle, it can be seen that the available capacity of the rechargeable battery in a case where charging and discharging is performed with charging voltage of 3.9V is great as compared to a case where charging and discharging is performed with the maximum charging voltage of 4.1V.

The initial available capacity of the rechargeable battery in a case where charging and discharging is performed with charging voltage of 3.8V is also relatively small at about 30% compared to a case where charging and discharging is performed with the maximum charging voltage of 4.1V. However, after the 600-th cycle, it can be seen that the available capacity of the rechargeable battery in a case where charging and discharging is performed with charging voltage of 3.8V is great compared to a case where charging and discharging is performed with the maximum charging voltage of 4.1V.

It can be seen that the available capacity of the rechargeable battery in a case where charging and discharging is performed with the charging voltage of 4.0V is highest in the 1000-th cycle.

Meanwhile, when charging and discharging is performed with the charging voltage of 3.7V, it can be seen that the available capacity is less than 50% of the design capacity in the zero-th cycle as well as the 1000-th cycle. The charging voltage 4.0V, 3.9V, and 3.8V is charging voltage within the range of 92% to 98% of the maximum charging voltage. The charging voltage 3.7V is charging voltage less than 92% of the maximum charging voltage. That is, when the charging voltage is less than 92% of the maximum charging voltage, it can be seen that the loss of the available capacity of the rechargeable battery is considerable.

When the reference cycle of the rechargeable battery 40 in the fuel cell hybrid system 100 is preferably at least 1000 cycles, and when applying the rechargeable battery used for the comparative testing to the fuel cell hybrid system 100, the charging voltage of the rechargeable battery to determine the first SOC may be determined as 4.0V to 3.8V. The charging voltage 4.0V, 3.9V, and 3.8V is charging voltage within the range of 92% to 98% of the maximum charging voltage.

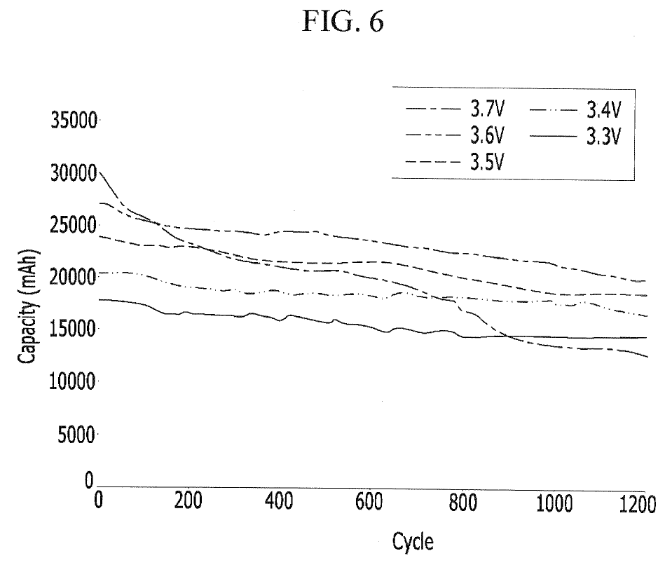

FIG. 6 is a graph illustrating still another example of comparative testing on a change in the available capacity of a rechargeable battery according to charging voltage. In the graph, a horizontal axis indicates the number of charge and discharge cycles and a vertical axis indicates the capacity (mAh) of the rechargeable battery.

Referring to FIG. 6, the graph shows results of performing charging and discharging using charging voltage 3.7V, 3.6V, 3.5V, 3.4V, and 3.3V with respect to a high-capacity low voltage lithium iron phosphate (LFP) type rechargeable battery of which maximum charging voltage is 3.7V. Compared to a lithium cobalt oxide (LCO) type rechargeable battery, the LFP type rechargeable battery has a low production cost, low deterioration, and a very long cycle-life.

Table 3 is the example of comparative testing on a change in the available capacity of the LFP type rechargeable battery using charging voltage 3.7V, 3.6V, 3.5V, 3.4V and 3.3V.

TABLE 3

| | Capacity (mAh) | | | | |
|---|---|---|---|---|---|
| Cycle | 3.7 V | 3.6 V | 3.5 V | 3.4 V | 3.3 V |
| 0 | 30000 | 27000 | 24000 | 20500 | 17500 |
| 100 | 26000 | 25400 | 23000 | 20500 | 17000 |
| 200 | 23450 | 25000 | 23200 | 19500 | 16500 |
| 300 | 22950 | 25000 | 23000 | 19500 | 16500 |
| 400 | 22500 | 25000 | 22700 | 19500 | 15750 |
| 500 | 22500 | 24600 | 22600 | 19500 | 15900 |
| 600 | 20750 | 23780 | 22500 | 19500 | 15800 |
| 700 | 19000 | 22980 | 21590 | 19800 | 16000 |
| 800 | 17500 | 22180 | 20290 | 19500 | 15500 |
| 900 | 15360 | 21380 | 18990 | 19500 | 16500 |
| 1000 | 15000 | 20580 | 17690 | 19000 | 16500 |

The initial available capacity of the rechargeable battery in a case where charging and discharging is performed with charging voltage of 3.6V is small about 10% compared to a case where charging and discharging is performed with the maximum charging voltage of 3.7V. However, after the 200-th cycle, it can be seen that the available capacity of the rechargeable battery in a case where charging and discharging is performed with charging voltage of 3.6V is great compared to a case where charging and discharging is performed with the maximum charging voltage of 3.7V.

The initial available capacity of the rechargeable battery in a case where charging and discharging is performed with charging voltage of 3.5 V is small about 20% compared to a case where charging and discharging is performed with the maximum charging voltage of 3.7V. However, after the 300-th cycle, it can be seen that the available capacity of the rechargeable battery in a case where charging and discharging is performed with charging voltage of 3.5V is great compared to a case where charging and discharging is performed with the maximum charging voltage of 3.7V.

The initial available capacity of the rechargeable battery in a case where charging and discharging is performed with charging voltage of 3.4 V is relatively small at about 32% compared to a case where charging and discharging is performed with the maximum charging voltage of 3.7V. However, after the 700-th cycle, it can be seen that the available capacity of the rechargeable battery in a case where charging and discharging is performed with charging voltage of 3.4V is great compared to a case where charging and discharging is performed with the maximum charging voltage of 3.7V.

It can be seen that the available capacity of the rechargeable battery in a case where charging and discharging is performed with the charging voltage of 3.6V is highest in the 1000-th cycle.

Meanwhile, when charging and discharging is performed with the charging voltage of 3.3V, it can be seen that the available capacity is less than 55% of the design capacity in the 1000-th cycle. The charging voltage 3.3V is charging voltage less than 92% of the maximum charging voltage. That is, when the charging voltage is less than 92% of the maximum charging voltage, the loss of the available capacity of the rechargeable battery is great.

When the reference cycle of the rechargeable battery 40 in the fuel cell hybrid system 100 is assumed as 1000 cycles, and when applying the rechargeable battery used for the comparative test to the fuel cell hybrid system 100, the charging voltage of the rechargeable battery to determine the first SOC may be determined as 3.6V to 3.4V. The charging voltage 3.6V, 3.5V, and 3.4V is charging voltage within the range of 92% to 98% of the maximum charging voltage.

As described above, by performing charging and discharging with charging voltage lower than the maximum charging voltage by a predetermined level compared to a case where the rechargeable battery is charged and discharged with the maximum charging voltage, it is possible to decrease a capacity decrease rate of the rechargeable battery, thereby extending a cycle-life of the rechargeable battery.

Further, since the fuel cell hybrid system 100 decreases the reduction of capacity loss of the rechargeable battery 40, it is possible to reduce the design capacity of the rechargeable battery 40. Accordingly, it is possible to reduce production cost of the fuel cell hybrid system 100.

By reducing a boosting ratio of the DC/DC converter according to a decrease in the charging voltage of the rechargeable battery 40, it is possible to improve the efficiency of the DC/DC converter 20.

The referred drawings and the detailed description of the disclosed invention are only examples of the present invention and thus, are not used to restrict the meaning or limit the range of the present invention disclosed in the claims. Therefore, it will be understood that those skilled in the art may perform various modifications and equivalent embodiments from the description. Accordingly, the technical scope of the present invention will be determined based on technical spirits of the claims.

What is claimed is:

1. A fuel cell hybrid system, comprising:
a fuel cell stack to generate an electrical current;
a rechargeable battery;
a direct current to direct current(dc/dc) converter electrically connected to the fuel cell stack and the rechargeable battery; and
a control unit electrically connected to the dc/dc converter to control the charging of the rechargeable battery by causing the dc/dc converter to output the electrical current received from the fuel cell stack at a voltage level that is less than a maximum charging voltage of the rechargeable battery.

2. The fuel cell hybrid system recited in claim 1, wherein the dc/dc converter further comprises:
a first distributed resistance electrically connected to the fuel cell stack and the rechargeable battery; and
a second distributed resistance electrically connected to the first distributed resistance and the control unit,
wherein the control unit alters the voltage level to the rechargeable battery by altering a resistance level in at least one of either the first distributed resistance or the second distributed resistance.

3. The fuel cell hybrid system recited in claim 2, wherein the control unit alters the voltage level to the rechargeable battery by altering the resistance level in both the first distributed resistance and the second distributed resistance.

4. The fuel cell hybrid system recited in claim 2, further comprising:
a current measurement unit electrically connected to the fuel cell stack, the dc/dc converter and the control unit to measure the electrical voltage from the fuel cell stack and transmit a current amount signal to the control unit indicative of an amount electrical current being generated by the fuel cell stack.

5. The fuel cell hybrid system recited in claim 4, wherein the dc/dc converter further comprises:
a power converter electrically connected between the fuel cell stack and the rechargeable battery;
a first amplifier electrically connected between the control unit and the power converter; and
a second amplifier electrically connected between the first amplifier and the power converter;
wherein a first end of the first distributed resistor is connected to a first node located between the power converter and the rechargeable battery;
a second end of the first distributed resistor is connected to a second node located between an output of the first amplifier and an input of the second amplifier;
a first end of the second distributed resistor is connected to the second node; and
a second end of the second distributed resistor is connected to the output of the first amplifier.

6. The fuel cell hybrid system recited in claim 1, wherein the dc/dc converter includes a power converter, said power converter, further comprising:
a first switch;
a second switch;
an inductor; and
a capacitor,
wherein the first switch includes a gate connected to a switch controller included in the dc/dc controller, a first end of the first switch connected to the current measurement unit and a second end connected to a first end of the inductor;
the second switch includes a gate connected to the switch controller, a first end connected to the second end of the first switch and a second end connected to a first terminal of the fuel cell stack;
a second end of the inductor is connected to a first end of the capacitor; and
a second end of the capacitor is connected to a second terminal of the fuel cell stack.

7. The fuel cell hybrid system recited in claim 6, wherein the switch controller varies an on-duty cycle of the first switch and the second switch on the basis of the current amount signal.

8. The fuel cell hybrid system recited in claim 6, wherein the control unit transfers an analog control signal based upon the performance of the fuel cell stack as indicated by the current amount signal to the dc/dc converter, and
wherein upon receipt of the analog control signal the power conversion efficiency of the dc/dc converter is altered.

9. The fuel cell hybrid system recited in claim 7, wherein the switch controller varies the on-duty cycle of the first switch and the second switch on the basis of the analog control signal.

10. The fuel cell hybrid system recited in claim 9, wherein the control unit changes a voltage value of the analog control signal to set the charging voltage of the rechargeable battery.

11. The fuel cell hybrid system recited in claim 2, wherein at least one of the first distributed resistance and the second distributed resistance is a variable resistance resistor.

12. The fuel cell hybrid system recited in claim 2, wherein both the first distributed resistance and the second distributed resistance are variable resistance resistors.

13. The fuel cell hybrid system recited in claim 1, wherein the rechargeable battery is a lithium-ion rechargeable battery.

14. The fuel cell hybrid system recited in claim 13, wherein the charging voltage of the rechargeable battery is in a range of equal to or less than 4.1 volts and equal to or greater than 4.0 volts.

15. The fuel cell hybrid system recited in claim 13, wherein the lithium-ion rechargeable battery is charged and discharged in a high temperature environment.

16. The fuel cell hybrid system recited in claim 15, wherein the charging voltage of rechargeable battery is in a range of equal to or less than 4.0 volts and equal to or greater than 3.8 volts.

17. The fuel cell hybrid system recited in claim 14, wherein the rechargeable battery is utilized in a cellular phone.

18. The fuel cell hybrid system recited in claim 16, wherein the rechargeable battery is utilized in a navigation system.

19. The fuel cell hybrid system recited in claim 1, wherein the rechargeable battery is a lithium iron phosphate (LFP) rechargeable battery.

20. The fuel cell hybrid system recited in claim 19, wherein the charging voltage of rechargeable battery is in a range of equal to or less than charging voltage 3.6 volts and equal to or greater than 3.4 volts.
